(19) United States
(12) Patent Application Publication
(10) Pub. No.: US 2001/0032734 A1
(43) Pub. Date: Oct. 25, 2001

(54) Electrical cable

(76) Inventors: Peter Madry, Barsinghausen (DE); Jurgen Jacob, Stadthagen (DE)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/793,496

(22) Filed: Feb. 27, 2001

(30) Foreign Application Priority Data
Feb. 28, 2000 (EP) 00400534.4

(51) Int. Cl. H01B 7/00

(52) U.S. Cl. 174/121 R

(57) ABSTRACT

In an electrical cable with at least one insulated conductor, at least one screen made of a braid or a textile, and a sheath, the braid or textile (8, 13) includes metallic wires and yarns or threads made of a material which is able to swell upon the entrance of moisture.

### BACKGROUND OF THE INVENTION

The invention concerns an electrical cable of the type having at least one insulated conductor, at least one screen made of a braid or a textile, and a sheath.

Screens and/or shielding have been well known in cable technology for a considerable time. They serve to improve the bending endurance, and also for shielding in order to prevent radio interference and to minimize electrical influences from electrical devices. These types of shields generally consist of a metal wire braid. They additionally serve as a mechanical protection, for the conductance of leakage currents in case of faults, and as a protection against accidental contact.

Furthermore, electrical lines are known in which the insulated conductors (leads) are provided with a metallic braid in order to improve the environmental compatibility of such lines. In high-voltage and medium high-voltage cables, electrical shields fulfill the functions of potential control and delimitation of the electrical field, conduction of short-circuit, leakage, and charging currents, and protection against accidental electrical contact.

Such shields can consist of conductive plastic layers, e.g. in the case of the internal and external conducting layer, or of metallic bands, wires, or braids and/or textiles positioned over the external conducting layer.

In order to prevent water, which has penetrated the sheath, from spreading out in the longitudinal direction of the metallic screen region, it is known to seal the shield region with, e.g., powder or bands which can swell upon the entrance of moisture. These materials swell up upon the intrusion of moisture and fill up the cavities and gaps present in the shield region. In this way, the water which has penetrated is prevented from spreading out over wide regions in the longitudinal direction of the cable screen.

In one known solution, the sealing of the gaps between the shielding wires and the external conducting layer is performed with a coating layer made of a conductive, swelling nonwoven material or a combination of a conductive crepe paper and a nonconductive, swelling nonwoven material.

The use of powder made of material which is able to swell has been shown to be disadvantageous because the powder is dusty due to its low specific weight, and it is therefore irritating for the service personnel during manufacturing and also during cable mounting.

The handling of nonwoven materials and crepe paper can cause problems in manufacturing due to their low resistance to tearing.

In addition, the diameter of the cable is enlarged by the nonwoven material and the crepe paper.

### SUMMARY OF THE INVENTION

It is therefore an object of the present invention to provide a longitudinally waterproof screen for an electrical cable which is easy to handle, has a good shielding effect, and guarantees a secure longitudinal sealing.

This object is achieved according to the present invention by the use of a braid or textile comprising metallic wires and yarns or threads made of material which can swell upon the entrance of moisture.

In addition to achieving the objects described above, the cable according to the invention also has the advantage that the textile or braid can replace the screen wires and/or the so-called counter helix in a high-voltage or medium high-voltage cable. The textile then serves both as a contact element among the individual shielding wires and provides contact between the external conducting layer and a metallic external sheath which may be provided.

Further features and advantages of the invention will be apparent from the detailed disclosure and claims hereafter.

### BRIEF DESCRIPTION OF THE DRAWINGS

The invention will be described in more detail with reference to the accompanying drawings, wherein:

FIG. 1 schematically illustrates a cable structure according to a first embodiment of the invention; and

FIG. 2 schematically illustrates a cable structure according to a second embodiment of the invention.

### DETAILED DESCRIPTION OF THE INVENTION

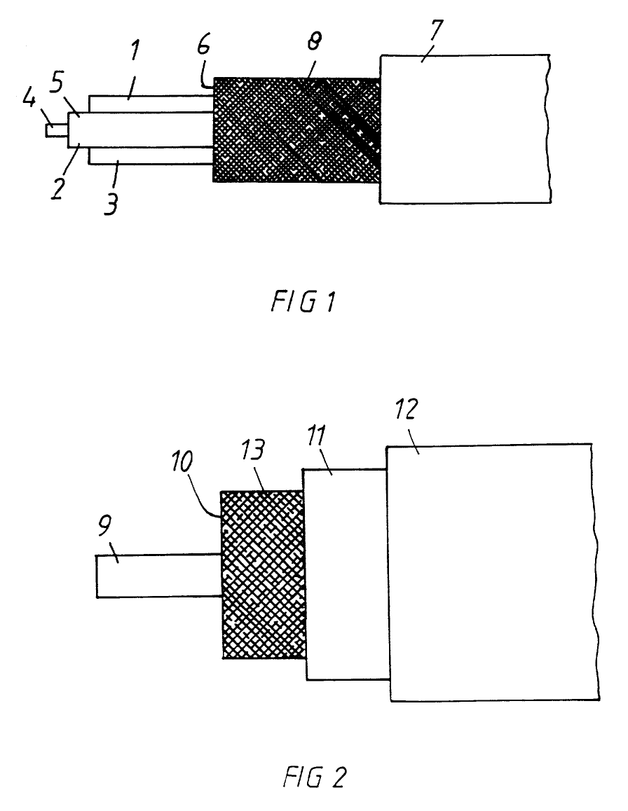

FIG. 1 shows a flexible line, comprising several leads 1, 2, and 3, which each including an electrical conductor 4 and an insulating layer 5 made of a thermoplastic surrounding the electrical conductor 4. The leads 1, 2, and 3 are surrounded by an internal sheath 6, upon which the external sheath 7, which is made of plastic, is extruded. Between the internal sheath 6 and the external sheath 7, a braid or textile 8 is positioned comprised of many metallic wires and a few threads or yarns (shown as dashed lines) made of a material which can swell upon the entrance of moisture.

The textile or braid 8, respectively, serves on the one hand as a mechanical protection and on the other hand as electromagnetic shielding.

In this connection, the textile or braid 8 can also be positioned on any of the leads 1, 2, and 3 in a way which is not shown.

In FIG. 2, a high-voltage cable is depicted which comprises a metallic conductor 9, a high-voltage proof insulation made of, for example, polyethylene, an internal sheath 11, and an external sheath 12.

The internal conducting layer on the electrical conductor 9 and the external conducting layer on the insulating layer 10 are not specifically shown. There is a textile or braid 13 on the external conducting layer which also comprises many metallic wires and a few threads or yarns (shown as dashed lines) made of a material which can swell upon the entrance of moisture.

In place of the internal sheath 11, an aluminum band coated on one side with copolymer can also be provided if a transverse seal of the sheath assembly against diffused-in moisture is required. In such cables, a screen layer of many wires is typically present. The textile or braid 11 is then positioned between the screen layer and the aluminum band, with the textile or braid 11 being on one hand a carrier for the sealing agent in case of moisture incursion, and, on the other hand, ensuring good contact among the wires of the screen layer and between the wires of the screen layer and the aluminum band.

The textile or braid 8 or 13, respectively, is present in the form of a band and is applied to the respective assembly element by winding.

The textile or braid is produced by using a thread or a yarn of a material which is able to swell in place of a few metal wires, or by additionally weaving in the threads or yarns in the intermediate spaces between the metal wires at predetermined distances. There is, however, also the possibility of applying the braid with a braider, with a few of the wires in both braiding directions replaced by threads or yarns of the material which swells upon the entrance of moisture.

According to a further development of the invention, the textile or braid can consist of elements which have a metal wire and a thread or yarn of material which is able to swell. The metal wire and the thread or the yarn can be stranded or twisted with one another or both can ran parallel to one another. The number of metal wires in the textile or braid should, however, exceed the number of elements consisting of metal wire and thread or yarn by severalfold.

What is claimed is:

1. An electrical cable with at least one insulated conductor, at least one screen made of a braid or textile, and a sheath, characterized in that the braid or textile (8, 13) comprises metallic wires and yarns or threads made of material which can swell upon the entrance of moisture.

2. An electrical cable according to claim 1, characterized in that in a metallic textile or braid (8, 13), yarns or threads made of material which can swell upon the entrance of moisture are inserted in at least a few of the intermediate spaces between the metal wires.

3. An electrical cable according to claim 1, characterized in that the braid or textile (8, 13) has elements which consist of metallic wires and yarns or threads of material which can swell upon the entrance of moisture.

4. An electrical cable according to claim 1, characterized in that the textile or braid (8, 13) is positioned on every lead and/or on an internal sheath (6) which encloses the leads or conductor of the cable.

5. An electrical cable according to claim 1, characterized in that the textile or braid (8, 13) is wound as a band-shaped body in a spiral on the lead and/or the internal sheath (6).

6. An electrical cable according to claim 1, characterized in that the number of metal wires is larger by at least a factor of three, and preferably a factor of seven, than the number of threads or yarns.
